(19) United States
(12) Patent Application Publication
(10) Pub. No.: US 2007/0049326 A1
(43) Pub. Date: Mar. 1, 2007

(54) MOBILE TERMINAL WITH INTERNAL ANTENNA STRUCTURE HAVING A SOUND RESONANCE CHAMBER

(75) Inventor: Sul-Ran Kim, Gyeonggi-Do (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/467,124

(22) Filed: Aug. 24, 2006

(30) Foreign Application Priority Data
Aug. 24, 2005 (KR) 78004/2005

(51) Int. Cl. H04M 1/00

(52) U.S. Cl. 455/550.1

(57) ABSTRACT

A mobile terminal comprising a sound output unit; and an internal antenna in communication with and located behind the sound output unit, wherein the internal antenna is adapted to allow transmission and reception of radio frequency signals, and formed to have a resonance chamber therein to allow resonance of sounds generated by the sound output unit.

### CROSS-REFERENCE TO RELATED APPLICATIONS

Pursuant to 35 U.S.C. § 119(a), this application claims the benefit of earlier filing date and right of priority to Korean Application No. 10-2005-0078004 filed on Aug. 24, 2005, the contents of which is hereby incorporated by reference herein in its entirety.

### BACKGROUND OF THE INVENTION

1. Field of the Invention

The present invention relates to a mobile terminal having a speaker unit and an internal antenna, and more particularly to a mobile terminal having a thin thickness and enhancing speaker sound quality.

2. Description of the Background Art

FIG. 1 is a perspective view showing a mobile terminal in accordance with the related art, and FIG. 2 is a disassembled perspective view showing the mobile terminal in accordance with the related art.

The related art portable (mobile) terminal comprises a display unit 102 having a display 104; a terminal body 110 rotatably connected to the display unit 102 by a hinge 120, having a key pad 112 for inputting information at a front surface thereof, having a battery 114 at a rear surface thereof, and having a printed circuit board (PCB) 106 therein; and an internal antenna 130 mounted in the terminal body 110 for transmitting and receiving signals.

A pair of speakers 132 for generating sound are mounted at the display unit 1021 and a receiver 134 for outputting voice information is mounted between the speakers 132. Also, a microphone 136 for inputting voice information is mounted at the terminal body 110.

The internal antenna 130 is mounted at the hinge 120 of the terminal body 120 in a width direction of the terminal body, and an antenna receiving portion 138 for receiving the internal antenna 130 is provided in the terminal body 110.

However, the related art portable terminal has the following problem. When a resonance box for enhancing a resonant effect of sound outputted from the speaker is installed within the portable terminal, a thickness of the portable terminal is increased. If the size of the resonance box is made smalle, the resulting sound quality would then be decreased. Also, the required amount of space within the body of the terminal to accommodate an adequate sized resonance box results in less space for other components.

### SUMMARY OF THE INVENTION

One aspect of the present invention is that the present inventor recognized certain problems of the related art. Based upon this recognition, the features of the present invention have been developed. The present invention provides a portable (mobile) terminal capable of being implemented to be slim and enhancing a sound quality from a speaker unit by utilizing an inner space of an antenna as a resonance box (i.e., resonance chamber) of the speaker unit.

The foregoing and other aspects of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a portable terminal in accordance with the related art;

FIG. 2 is a disassembled perspective view showing the portable terminal in accordance with the related art;

FIG. 3 is a perspective view showing a closed state of a portable terminal according to a first embodiment of the present invention;

FIG. 4 is a perspective view showing an opened state of the portable terminal according to a first embodiment of the present invention;

FIG. 5 is a sectional view of the portable terminal according to a first embodiment of the present invention;

FIG. 6 is a frontal view of a printed circuit board according to a first embodiment of the present invention;

FIG. 7 is a perspective view of an antenna according to a first embodiment of the present invention; and

FIG. 8 is a sectional view of a portable terminal according to a second embodiment of the present invention.

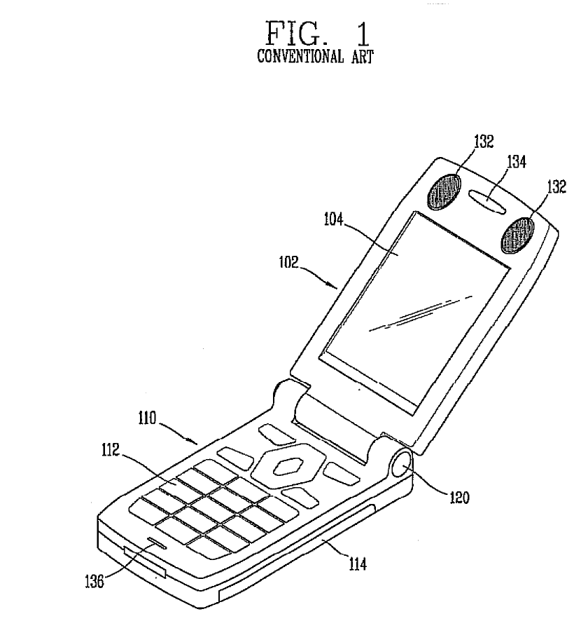

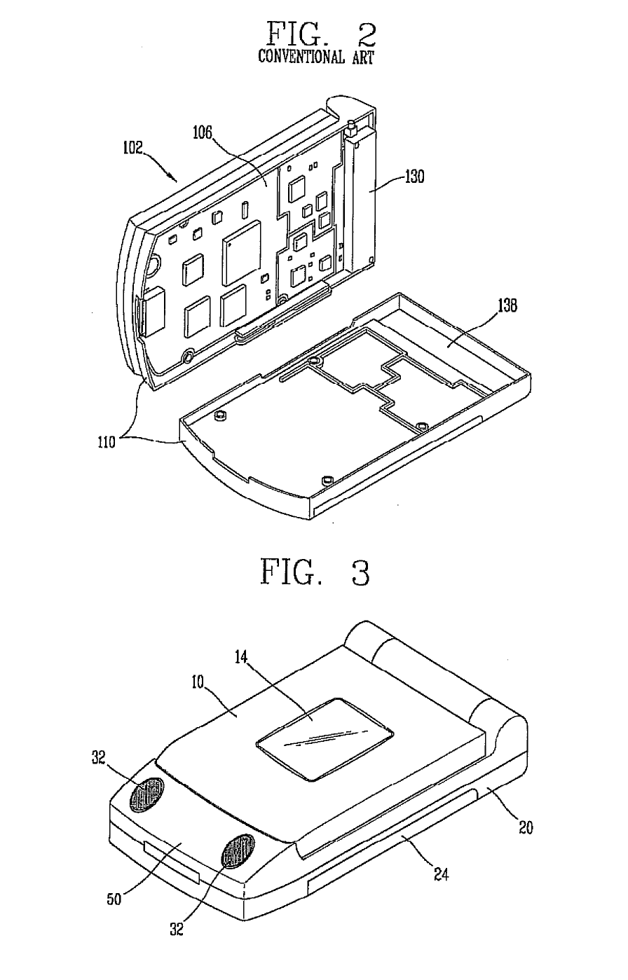

### DETAILED DESCRIPTION OF THE INVENTION

Reference will now be made in detail to some embodiments of the present invention, examples of which are illustrated in the accompanying drawings.

Hereinafter, a portable terminal according to the present invention will be explained. A portable terminal may also be referred to as a mobile communication terminal, a mobile phone, or other wireless communication device.

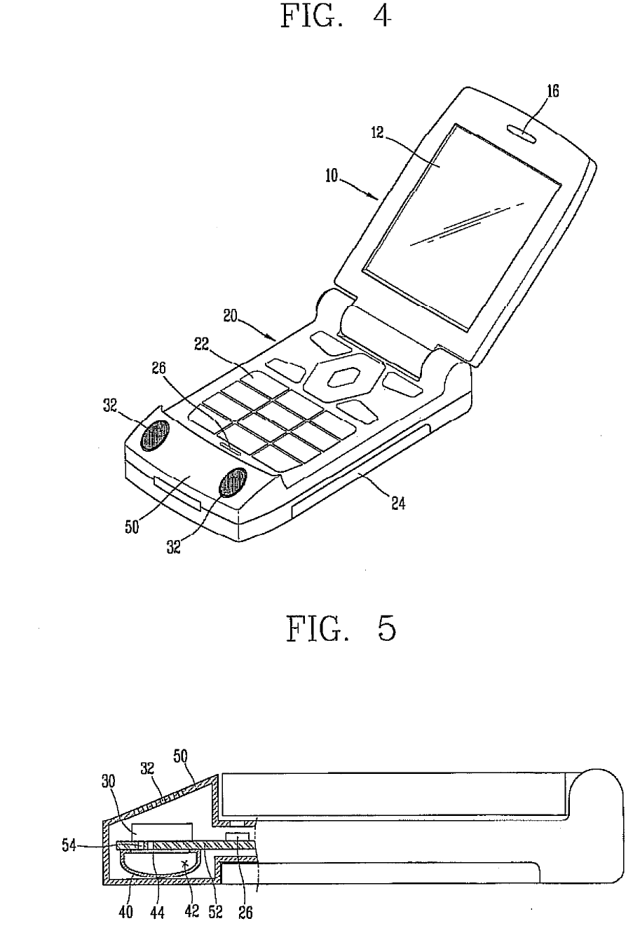

FIG. 3 is a perspective view showing a closed state of a portable terminal according to a first embodiment of the present invention, FIG. 4 is a perspective view showing an opened state of the portable terminal according to a first embodiment of the present invention, and FIG. 5 is a sectional view of the portable terminal according to a first embodiment of the present invention.

The portable terminal according to a first embodiment of the present invention comprises: a display unit 10 having a main display 12 for displaying information; a terminal body 20 openably connected to the display unit 10, having key buttons 22 (or other user input means) for inputting information, and having a battery 24; a speaker unit 30 (i.e., comprising a cone or diaphragm type speaker, a piezoelectric type speaker, a sound generator, a sound output unit, etc.) mounted at the terminal body 20 for generating sound; and an antenna 40 mounted at the terminal body 20 to allow signal transmission and reception and having a (sound or sonic) resonance chamber (i.e., space or cavity) serving as a resonance box (or enclosure) of the speaker unit 30.

The portable terminal can be applied not only to a folder type but also to a bar type, a slide type, a swing type, etc.

A subsidiary display 14 for displaying information when the portable terminal is in a closed state may be provided at an outer surface of the display unit 10. Also, a receiver 16 for outputting voice signals when a call is received may be provided at an inner surface of the display unit 10. A microphone 26 is mounted at the terminal body 20.

A mounting portion 50 (i.e., an end portion of the mobile terminal near a microphone or mouthpiece) for mounting the speaker unit 30 and the antenna 40 is formed at the terminal body 20. The mounting portion 50 is formed at a lower end of the terminal body 20, and may have a thickness that is greater than that of the terminal body 20 or made to be flush thereof. The display unit 10 may be formed to have a length shorter than that of the terminal body 20 so as not to cover the mounting portion 50.

An upper surface of the mounting portion 50 may be formed as an inclined surface having a certain inclination angle. Sound holes 32 for passing sounds generated from the speaker unit 30 mounted in the mounting portion 50 may be formed at the inclination surface.

The speaker unit 30 is provided at the terminal body 20 in one pair having a certain gap therebetween along a width direction of the terminal body 20.

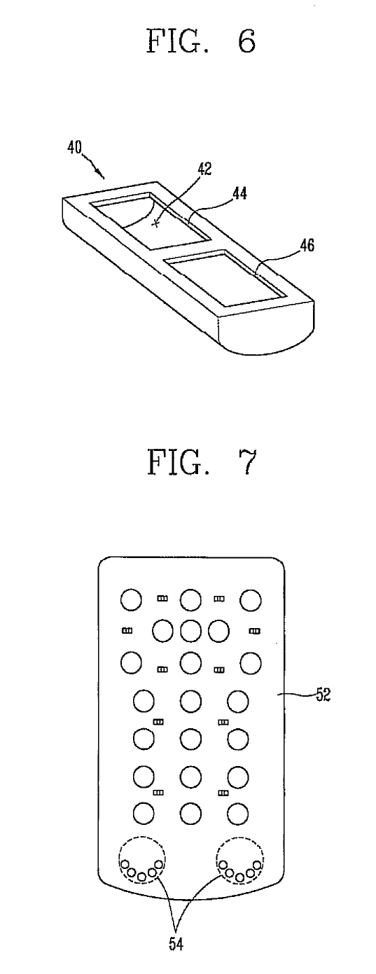

As shown in FIG. 6, the antenna 40 is mounted at a lower surface of the speaker unit 30, and is implemented as a hollow box shape having an inner space 42 serving as a resonance box of the speaker unit 30. Openings 44 connected to each rear surface of the speakers are provided at the antenna 40.

One opening 44 of the antenna 40 is connected to a rear surface of one speaker, and another opening 46 is connected to a rear surface of another speaker.

A printed circuit board (PCB) 52 is installed between the speaker unit 30 and the antenna 40. That is, the speaker unit 30 is installed at an upper surface of the printed circuit board 521 and the antenna 40 is installed at a lower surface of the printed circuit board 52. As shown in FIG. 7, a plurality of passages 54 for connecting the rear surface of the speaker unit 30 to the openings 44 and 46 of the antenna 40 are penetratingly formed at the printed circuit board 52.

The antenna 40 is connected to the printed circuit board 52 by a feeding port and a ground port, to allow signal transmission and reception with the printed circuit board 52.

In the portable terminal according to the present invention, the mounting portion having a thickness thicker than that of the terminal body is formed at a lower end of the terminal body, and the speaker unit and the antenna are mounted in the mounting portion. The antenna is provided with an inner space connected to a rear surface of the speaker. Since the inner space of the antenna is utilized as a resonance box for enhancing a resonant effect of sound emitted from the speaker unit, a sound quality from the speaker unit can be enhanced without increasing the thickness of the portable terminal.

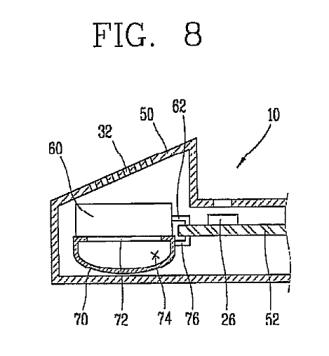

FIG. 8 is a sectional view of a portable terminal according to a second embodiment of the present invention.

In the portable terminal according to the second embodiment of the present invention, a mounting portion 50 is at a lower end of a terminal body 10, and a speaker unit 60 and an antenna 70 are mounted in the mounting portion 50. Also, the antenna 70 directly contacts with a lower surface of the speaker unit 60 that can be tightly (snuggly) connected to an opening 72 of the antenna 70. Accordingly, an inner space 74 of the antenna 70 serves as a resonance box (i.e., sonic resonance chamber) of the speaker unit 60.

That is, in the portable terminal according to the second embodiment of the present invention, the antenna 70 and the speaker unit 60 directly come in contact with each other, thereby further decreasing the thickness the portable terminal.

The speaker unit 60 and the antenna 70 are connected to the printed circuit board 52 by connection lines (or electrical leads) 62 and 76, respectively.

The antenna according to the second embodiment may have the same structure as that of the antenna according to the first embodiment, and thus its minute explanation will be omitted.

In the portable terminal according to the present invention, the antenna is provided with an inner space serving as a resonance box of the speaker unit. Accordingly, a sound quality from the speaker unit can be enhanced while the thickness of the portable terminal can be maintained to have a slim profile.

Another embodiment of the present invention can be contemplated. Namely, referring to FIG. 8, the speaker unit 60 may be attached directly onto an inner surface of the mounting portion 50 without any gap therebetween. Doing so will allow more internal space within the mounting portion 50 for a larger sized sonic resonance chamber to be formed in the antenna 70. A larger sonic resonance chamber can allow improved sound quality.

Additionally, a so-called bass reflex port (or other type of opening) may be provided at the antenna 70 to allow better resonance for low frequency sound waves, which would result in improved reproduction of deeper (lower) sounds.

The antenna having a sonic resonance chamber therein described above may be made of various types of materials. The entire antenna may be metallic or only certain portions thereof may be made of metal. As long as the characteristics of the material(s) used to form the antenna provide the desired antenna properties, any combination of materials may be used.

Also, the configuration of the antenna itself may take many forms. As long as the necessary antenna properties as well as the desired sonic resonance effects can be obtained, the openings of the antenna, the rear curved portion, the side walls and the like may have various shapes and sizes. The present invention provides a mobile terminal comprising: a sound output unit; and an internal antenna in communication with and located behind the sound output unit, wherein the internal antenna is adapted to allow transmission and reception of radio frequency signals, and formed to have a resonance chamber therein to allow resonance of sounds generated by the sound output unit.

The sound output unit may comprise a set of speakers. The internal antenna may comprise: a front portion having openings that correspond to the speakers and allow sound waves to pass therethrough; and a back portion that encloses a rear surface of the front portion to form the resonance chamber, wherein the back portion has a curved inner surface that allows sound wave resonance

The mobile terminal may further comprise: a body in which the sound output unit and the internal antenna are located; and a PCB provided within the body and having various components that are electrically connected with the sound output unit and the internal antenna. The sound output unit and the internal antenna may be respectively mounted on opposing surfaces of the PCB in a corresponding manner. The PCB has openings that allow sound waves to pass between the sound output unit and the internal antenna. The sound output unit and the internal antenna may be attached together, and have respective electrically connections with the PCB that is located adjacent thereto. The body may comprise: a main section in which the sound output unit and the internal antenna are located; and a moveable section operatively connected with the main section. The main section and the moveable section may form a folder type configuration, a slider type configuration, or a swivel type configuration. The main section further comprises: a microphone located adjacent to the sound output unit and adapted to operate as a sound pick-up device for the mobile terminal.

Also, the present invention provides a portable terminal, comprising: a terminal body; a speaker unit mounted in the terminal body for generating sound; and an antenna mounted in the terminal body for sending and receiving signals and having an inner space serving as a resonance box of the speaker unit.

The antenna may be mounted at a rear surface of the speaker unit, and the inner space of the antenna is connected to the rear surface of the speaker unit. The antenna may have a hollow box shape, and is provided with at least one opening at one side thereof. The speaker may be mounted at one surface of a printed circuit board, the antenna is mounted at an opposing surface of the printed circuit board, and a passage for connecting the rear surface of the speaker to the inner space of the antenna is formed at the printed circuit board.

Furthermore, the present invention provides a portable terminal, comprising: a terminal body; a display unit openably attached to the terminal body; and a speaker unit and an antenna provided at a mounting portion formed in the terminal body, wherein an inner space of the antenna serves as a resonance box of the speaker unit.

The mounting portion may be formed at one end of the terminal body. Sound emitting holes that allow passing of sounds generated from the speaker may be formed at the mounting portion.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a sound output unit; and
an internal antenna in communication with and located behind the sound output unit,
wherein the internal antenna is adapted to allow transmission and reception of radio frequency signals, and formed to have a resonance chamber therein to allow resonance of sounds generated by the sound output unit.

2. The mobile terminal of claim 1, wherein the sound output unit comprises a set of speakers.

3. The mobile terminal of claim 2, wherein the internal antenna comprises:
a front portion having openings that correspond to the speakers and allow sound waves to pass therethrough; and
a back portion that encloses a rear surface of the front portion to form the resonance chamber,
wherein the back portion has a curved inner surface that allows sound wave resonance.

4. The mobile terminal of claim 1, further comprising:
a body in which the sound output unit and the internal antenna are located; and
a PCB provided within the body and having various components that are electrically connected with the sound output unit and the internal antenna.

5. The mobile terminal of claim 4, wherein the sound output unit and the internal antenna are respectively mounted on opposing surfaces of the PCB in a corresponding manner.

6. The mobile terminal of claim 5, wherein the PCB has openings that allow sound waves to pass between the sound output unit and the internal antenna.

7. The mobile terminal of claim 4, wherein the sound output unit and the internal antenna are attached together, and have respective electrically connections with the PCB that is located adjacent thereto.

8. The mobile terminal of claim 4, wherein the body comprises:
a main section in which the sound output unit and the internal antenna are located; and
a moveable section operatively connected with the main section.

9. The mobile terminal of claim 8, wherein the main section and the moveable section form a folder type configuration, a slider type configuration, or a swivel type configuration.

10. The mobile terminal of claim 9, wherein the main section further comprises:
a microphone located adjacent to the sound output unit and adapted to operate as a sound pick-up device for the mobile terminal.

11. A portable terminal, comprising:
a terminal body;
a speaker unit mounted in the terminal body for generating sound; and
an antenna mounted in the terminal body for sending and receiving signals and having an inner space serving as a resonance box of the speaker unit.

12. The portable terminal of claim 11, wherein the antenna is mounted at a rear surface of the speaker unit, and the inner space of the antenna is connected to the rear surface of the speaker unit.

13. The portable terminal of claim 11, wherein the antenna has a hollow box shape, and is provided with at least one opening at one side thereof.

14. The portable terminal of claim 11, wherein the speaker is mounted at one surface of a printed circuit board, the antenna is mounted at an opposing surface of the printed circuit board, and a passage for connecting the rear surface of the speaker to the inner space of the antenna is formed at the printed circuit board.

15. A portable terminal, comprising:
a terminal body;
a display unit openably attached to the terminal body; and
a speaker unit and an antenna provided at a mounting portion formed in the terminal body,
wherein an inner space of the antenna serves as a resonance box of the speaker unit.

16. The portable terminal of claim 15, wherein the mounting portion is formed at one end of the terminal body.

17. The portable terminal of claim 16, wherein sound emitting holes that allow passing of sounds generated from the speaker are formed at the mounting portion.
